(19) United States
(12) Patent Application Publication
(10) Pub. No.: US 2024/0378870 A1
(43) Pub. Date: Nov. 14, 2024

(54) UNIFIED FRAMEWORK FOR VISION PROMPT TUNING

(71) Applicant: NEC Laboratories America, Inc., Princeton, NJ (US)

(72) Inventors: Wei Cheng, Princeton Junction, NJ (US); Yanchi Liu, Princeton, NJ (US); Haifeng Chen, West Windsor, NJ (US); Xianjun Yang, Santa Barbara, CA (US)

(21) Appl. No.: 18/650,174

(22) Filed: Apr. 30, 2024

Related U.S. Application Data
(60) Provisional application No. 63/500,654, filed on May 8, 2023.

(51) Int. Cl. G06V 10/778; G06V 10/82

(52) U.S. Cl. CPC G06V 10/778; G06V 10/82

(57) ABSTRACT

Systems and methods are provided for dynamic prompt tuning in image processing, including decomposing a received image into segments sized to balance detail retention and computational efficiency for processing by an embedding algorithm designed for token generation, generating tokenized image data by transforming each of the decomposed segments into a sequence of tokens using an embedding process that includes a convolutional neural network, and dynamically computing parameters for inserting prompts into the sequence of tokens, including a position and length of the prompts, utilizing a one-layer neural network combined with a continuous relaxation of a discrete distribution for optimizing categorical decision-making. Soft prompts are created based on the dynamically computed parameters and the soft prompts are integrated with the tokenized image data. The integrated image data and prompts are processed using a pretrained vision model with a frozen backbone to enhance image feature recognition.

### RELATED APPLICATION INFORMATION

This application claims priority to U.S. Provisional App. No. 63/500,654, filed on May 8, 2023, incorporated herein by reference in its entirety.

### BACKGROUND

### Technical Field

The present invention relates to image processing and enhancement, and more particularly to a system and method for automated, artificial intelligence driven image processing and enhancement by dynamically tuning prompt parameters to enhance feature recognition and interpretation across various image processing applications.

### Description of the Related Art

In the field of image processing, conventional systems and methods utilize static parameters and fixed algorithms to enhance and interpret images. These conventional techniques, including various forms of convolutional neural networks and standard image segmentation, rely on preset conditions and are limited in their adaptability to diverse or changing image content. As a result, they struggle with dynamically adapting to real-time variations in image data, which is important for real-world image processing tasks, in particular for applications requiring rapid and accurate image analysis, such as, for example, autonomous driving, real-time surveillance, quality control in manufacturing facilities, etc. Moreover, conventional systems and methods require extensive training data, which is costly, processor resource requirement intensive, and time-consuming to acquire, especially for less common scenarios or features. This highlights the pressing need for a more flexible and efficient approach capable of real-time tuning and adaptation without the heavy reliance on comparatively large labeled datasets, as required by conventional systems and methods for image processing.

### SUMMARY

According to an aspect of the present invention, a method is provided for dynamic prompt tuning in image processing, including decomposing a received image into segments sized to balance detail retention and computational efficiency for processing by an embedding algorithm designed for token generation, generating tokenized image data by transforming each of the decomposed segments into a sequence of tokens using an embedding process that includes a convolutional neural network, and dynamically computing parameters for inserting prompts into the sequence of tokens, including a position and length of the prompts, utilizing a one-layer neural network combined with a continuous relaxation of a discrete distribution for optimizing categorical decision-making. Soft prompts are created based on the dynamically computed parameters and the soft prompts are integrated with the tokenized image data. The integrated image data and prompts are processed using a pretrained vision model with a frozen backbone to enhance image feature recognition.

According to another aspect of the present invention, a system is provided for dynamic prompt tuning in image processing, including a processor device and a memory storing instructions that when executed by the processor device, cause the system to decompose a received image into segments sized to balance detail retention and computational efficiency for processing by an embedding algorithm designed for token generation, generate tokenized image data by transforming each of the decomposed segments into a sequence of tokens using an embedding process that includes a convolutional neural network, and dynamically compute parameters for inserting prompts into the sequence of tokens, including a position and length of the prompts, utilizing a one-layer neural network combined with a continuous relaxation of a discrete distribution for optimizing categorical decision-making. Soft prompts are created based on the dynamically computed parameters and the soft prompts are integrated with the tokenized image data. The integrated image data and prompts are processed using a pretrained vision model with a frozen backbone to enhance image feature recognition.

According to another aspect of the present invention, a computer program product is provided for dynamic prompt tuning in image processing, including instructions to decompose a received image into segments sized to balance detail retention and computational efficiency for processing by an embedding algorithm designed for token generation, generate tokenized image data by transforming each of the decomposed segments into a sequence of tokens using an embedding process that includes a convolutional neural network, and dynamically compute parameters for inserting prompts into the sequence of tokens, including a position and length of the prompts, utilizing a one-layer neural network combined with a continuous relaxation of a discrete distribution for optimizing categorical decision-making. Soft prompts are created based on the dynamically computed parameters and the soft prompts are integrated with the tokenized image data. The integrated image data and prompts are processed using a pretrained vision model with a frozen backbone to enhance image feature recognition.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block diagram illustratively depicting an exemplary processing system to which the present invention may be applied, in accordance with embodiments of the present invention;

FIG. 2 is a diagram illustratively depicting a high-level view of a method for automated, dynamic prompt tuning for image processing and enhancement, in accordance with embodiments of the present invention;

FIG. 3A is a diagram illustratively depicting a method for prompt position optimization and selection in dynamic prompt tuning for image processing and enhancement, in accordance with embodiments of the present invention;

FIG. 3B is a diagram illustratively depicting a method for prompt length optimization and selection in dynamic prompt tuning for image processing and enhancement, in accordance with embodiments of the present invention;

FIG. 4 is a diagram illustratively depicting a method for automated image processing and enhancement by integrated management and dynamic adjustment of soft prompts across various computer vision and image processing tasks, in accordance with embodiments of the present invention;

FIG. 5 is a diagram illustratively depicting a system and method for automated, multi-task dynamic prompt tuning across various computer vision and image processing tasks in multiple exemplary environments, in accordance with embodiments of the present invention;

FIG. 6 is a diagram illustratively depicting a system and method for enhanced vision model analysis using dynamic prompt tuning, in accordance with embodiments of the present invention;

FIG. 7 is a diagram illustratively depicting a system and method for automated, multi-task dynamic prompt tuning for image processing and enhancement, in accordance with embodiments of the present invention; and

FIG. 8 is a diagram illustratively depicting a high-level view of a system for automated image processing and enhancement using dynamic prompt tuning, in accordance with embodiments of the present invention.

### DETAILED DESCRIPTION

In accordance with embodiments of the present invention, system and methods are provided for enhancing the efficacy of image processing using dynamic prompt tuning techniques. The core of the invention lies in its ability to dynamically adjust the insertion position, length, and content of prompts used in conjunction with pre-trained vision models, thereby significantly improving the model's performance across various vision tasks such as image classification, object detection, and beyond. By integrating a set of learnable parameters that can be tailored on a per-instance or task-level basis, the system can elicit knowledge from vision models more effectively compared to traditional prompt tuning methods.

The present invention introduces a novel approach to fine-tune large-scale vision transformer models by inserting prompts that are optimized in real-time for position and length, addressing the limitations of fixed soft prompts. This dynamic prompt tuning allows the system to adapt to the unique requirements of each image instance and processing task, outperforming existing methods in many cases while reducing the storage costs associated with model fine-tuning. The system can leverage a one-layer neural network and a continuous relaxation of a discrete distribution (e.g., Gumbel-Softmax distribution) to learn the categorical distribution of positions or lengths, enabling the fine-tuning of prompts at a granular level. Such an approach ensures that the processing of image data is not only efficient but also nuanced, accommodating the variability inherent in real-world applications. Moreover, the system's ability to generate instance-aware prompts supports a higher degree of specificity and relevance in image processing tasks, making this technology a significant advancement in the field of computer vision.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid-state memory, magnetic tape, a removable computer diskette, a random-access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

Aspects of the present invention are described below with reference to flowchart illustrations and/or block diagrams of methods, systems, and computer program products according to embodiments of the present invention. It is noted that each block of the flowcharts and/or block diagrams, and combinations of blocks in the flowcharts and/or block diagrams, may be implemented by computer program instructions.

The flowchart and block diagrams in the figures illustrate the architecture, functionality, and operation of possible implementations of systems, methods, and computer program products according to various embodiments of the present invention. Each block in the flowchart or block diagrams may represent a module, segment, or portion of code, which comprises one or more executable instructions for implementing the specified logical function(s), and in some alternative implementations of the present invention, the functions noted in the block may occur out of the order noted in the figures. For example, two blocks shown in succession may, in fact, be executed substantially concurrently, may sometimes be executed in reverse order, or may be executed in any other order, depending on the functionality of a particular embodiment.

It is also noted that each block of the block diagrams and/or flowchart illustration, and combinations of blocks in the block diagrams and/or flowchart illustration, can be implemented by specific purpose hardware systems that perform the specific functions/acts, or combinations of special purpose hardware and computer instructions according to the present principles.

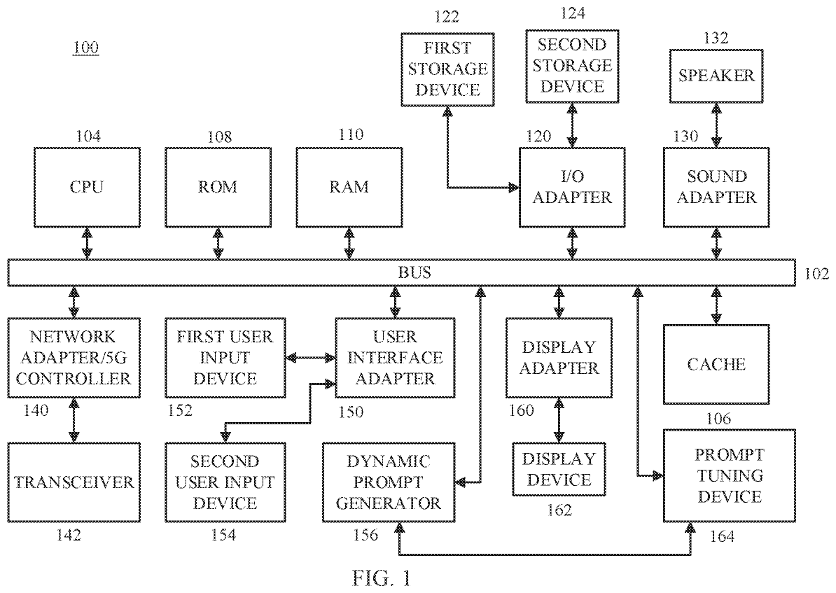

Referring now to the drawings in which like numerals represent the same or similar elements and initially to FIG. 1, an exemplary processing system 100, to which the present principles may be applied, is illustratively depicted in accordance with embodiments of the present principles.

In some embodiments, the processing system 100 can include at least one processor (CPU) 104 operatively coupled to other components via a system bus 102. A cache 106, a Read Only Memory (ROM) 108, a Random Access Memory (RAM) 110, an input/output (I/O) adapter 120, a sound adapter 130, a network adapter 140, a user interface adapter 150, and a display adapter 160, are operatively coupled to the system bus 102.

A first storage device 122 and a second storage device 124 are operatively coupled to system bus 102 by the I/O adapter 120. The storage devices 122 and 124 can be any of a disk storage device (e.g., a magnetic or optical disk storage device), a solid-state magnetic device, and so forth. The storage devices 122 and 124 can be the same type of storage device or different types of storage devices.

A speaker 132 is operatively coupled to system bus 102 by the sound adapter 130. A transceiver 142 is operatively coupled to system bus 102 by network adapter 140. A display device 162 is operatively coupled to system bus 102 by display adapter 160. A Vision Language (VL) model can be utilized in conjunction with a predictor device 164 for input text processing tasks, and can be further coupled to system bus 102 by any appropriate connection system or method (e.g., Wi-Fi, wired, network adapter, etc.), in accordance with aspects of the present invention.

A first user input device 152 and a second user input device 154 are operatively coupled to system bus 102 by user interface adapter 150. The user input devices 152, 154 can be one or more of any of a keyboard, a mouse, a keypad, an image capture device, a motion sensing device, a microphone, a device incorporating the functionality of at least two of the preceding devices, and so forth. A dynamic prompt generator 156 to extract knowledge from pre-trained vision models can be included in a system with one or more storage devices, communication/networking devices (e.g., WiFi, 4G, 5G, Wired connectivity), hardware processors, etc., in accordance with aspects of the present invention. In various embodiments, other types of input devices can also be used, while maintaining the spirit of the present principles. The user input devices 152, 154 can be the same type of user input device or different types of user input devices. The user input devices 152, 154 are used to input and output information to and from system 100, in accordance with aspects of the present invention. The dynamic prompt generator 156 can be utilized with a learnable neural network to automatically select insertion positions and prompt length, and a prompt tuning device 164 can be operatively connected to the system 100 for further refining the generated prompts for any of a plurality of tasks (e.g., image classification, object detection, etc.), in accordance with aspects of the present invention.

Of course, the processing system 100 may also include other elements (not shown), as readily contemplated by one of skill in the art, as well as omit certain elements. For example, various other input devices and/or output devices can be included in processing system 100, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the processing system 100 are readily contemplated by one of ordinary skill in the art given the teachings of the present principles provided herein.

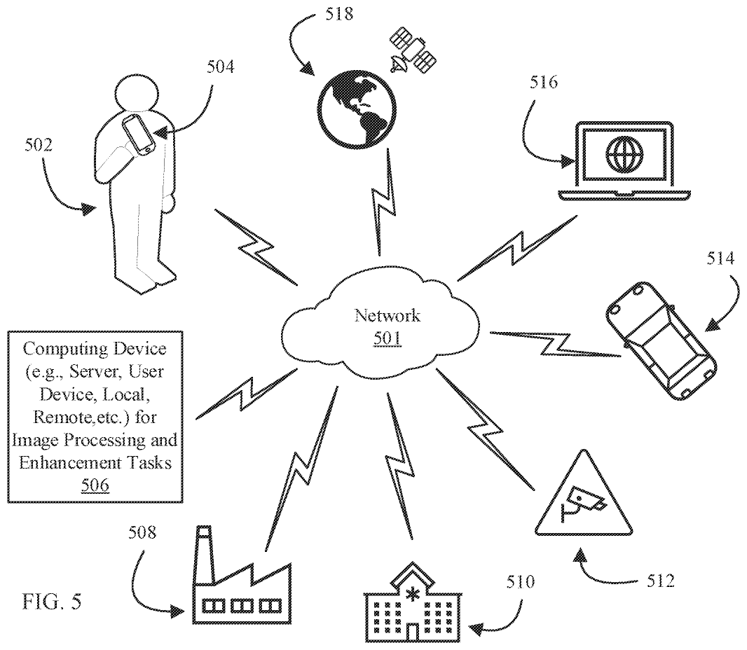

Moreover, it is to be appreciated that systems 500, 600, 700, and 800, described below with respect to FIGS. 5, 6, 7, and 8, respectively, are systems for implementing respective embodiments of the present invention. Part or all of processing system 100 may be implemented in one or more of the elements of systems 500, 600, 700, and 800, in accordance with aspects of the present invention.

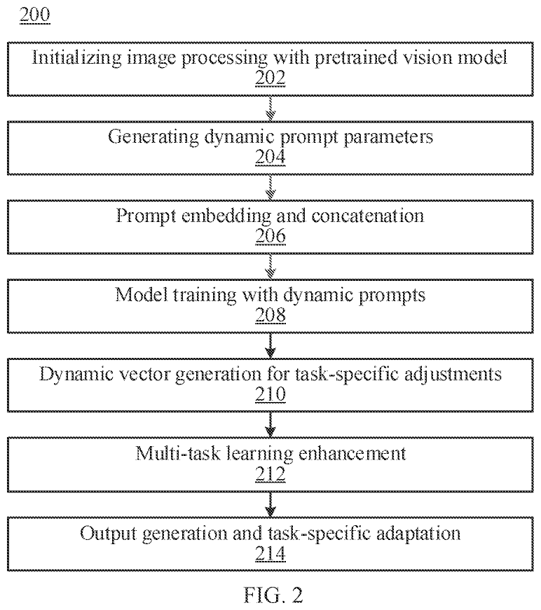

Further, it is to be appreciated that processing system 100 may perform at least part of the methods described herein including, for example, at least part of methods 200, 300, 400, 500, 600, and 700, described below with respect to FIGS. 2, 3A, 3B, 4, 5, 6, and 7, respectively. Similarly, part or all of systems 500, 600, 700, and 800 may be used to perform at least part of methods 200, 300, 400, 500, 600, and 700 of FIGS. 2, 3A, 3B, 4, 5, 6, and 7, respectively, in accordance with aspects of the present invention.

As employed herein, the term “hardware processor subsystem,” “processor,” or “hardware processor” can refer to a processor, memory, software, or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs). These and other variations of a hardware processor subsystem are also contemplated in accordance with embodiments of the present invention.

Referring now to FIG. 2, a high-level view of a method 200 for automated, dynamic prompt tuning for image processing and enhancement, is illustratively depicted in accordance with embodiments of the present invention.

In various embodiments, in block 202, an image can be received and prepared for processing. This step can include decomposing the image into manageable segments or patches. Each segment can then be subjected to an embedding process using a convolutional neural network (CNN) or a similar feature extraction method. This process can transform each image patch into a tokenized format suitable for input into the vision model, leveraging a pre-trained vision transformer (ViT). The selection of the CNN or embedding technique can be adaptable based on the specific characteristics of the image and desired outputs or requirements of the subsequent processing steps.

In block 204, a one-layer neural network, integrated with a Gumbel-Softmax distribution, can dynamically compute the optimal parameters for prompt insertion, such as position and length. This computation can be crucial for customizing the prompt tuning process to fit specific images and tasks, determining where and how long the prompts should be inserted in the token sequence. The flexibility in parameter computation allows for the model to adjust to the varying complexities and specificities of different image datasets and task requirements. In block 206, based on the parameters generated in block 204, soft prompts can be created and strategically integrated within the tokenized image data. The integration can occur at specified positions within the sequence, ensuring that the prompts effectively augment the pre-trained model's ability to process distinctive image features. The choice of prompt length and position can be tailored to enhance the model's interpretability and responsiveness to the input data.

In block 208, the combined data from block 206 is fed into the frozen backbone of the pretrained vision model. Only the prompts and certain trainable parameters of the model are updated during this phase, focusing on optimizing the model's performance for specific tasks or datasets through selective tuning. This selective tuning approach can minimize the computational load and enhance the model's efficiency by limiting the number of trainable parameters. In block 210, a method of dynamic vector generation is employed where a set of prompt pools can be created, and through a learned network, specific prompts can be selected based on their relevance to the task at hand. This step can enable the model to adaptively respond to different tasks by selecting the most effective prompts from a predefined pool, enhancing performance and efficiency. This dynamic adaptation can be especially useful in applications requiring high precision and variability in responses, such as in different types of image recognition tasks.

In block 212, where the model is expected to perform multiple image-related tasks, such as classification, detection, or segmentation, the dynamic prompting system can be configured to support multi-task learning. This setup allows the model to leverage shared features and prompts across various tasks, improving generalization and reducing the overhead associated with task-specific tuning. Multi-task learning can be particularly beneficial in environments where computational resources are limited, and task diversity is high. In block 214, the final outputs can be generated by the model, where each output can be mapped to specific labels or categories as required by the task. The dynamic nature of the prompts and their configuration allows for refined output that is closely aligned with the task requirements, ensuring high accuracy and relevance. The adaptive capability of the model in this block can be enhanced through continuous learning mechanisms, where feedback from the task performance can be used to further refine the prompt parameters, in accordance with aspects of the present invention.

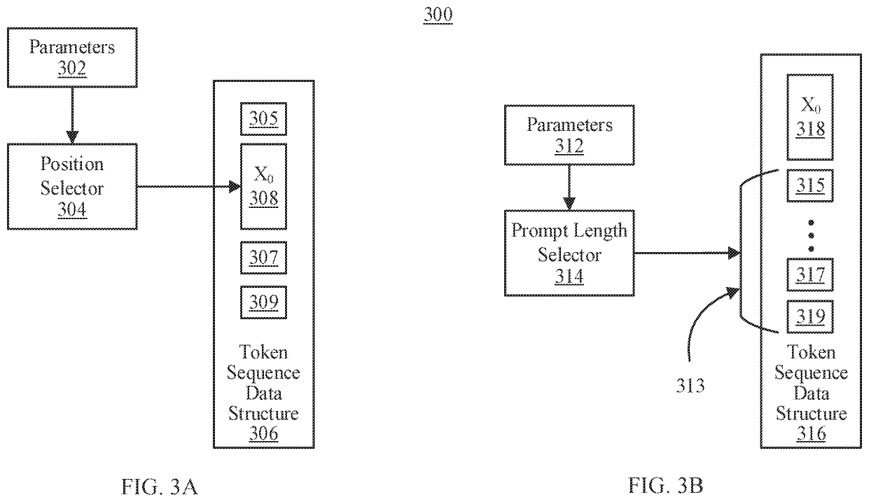

Referring now to FIGS. 3A and 3B, a diagram showing methods 300 for prompt position and prompt length optimization and selection in dynamic prompt tuning for image processing and enhancement, is illustratively depicted in accordance with embodiments of the present invention.

In various embodiments, in block 302, a pre-defined set of parameters, a user-defined set of parameters, and/or a set of parameters derived through an algorithmic process that accounts for various factors (e.g., a type of images being processed, specific objectives of the processing task at hand, empirical data from prior prompt tuning instances, etc.) can be received for processing. These parameters can include a comprehensive array of information, including but not limited to, the desirable lengths of the prompts that need to be inserted, the positions within the token sequence where these prompts might be most effective, and other nuances that could influence the model's interpretive accuracy. The process of parameter determination can be intricate, and can include utilizing machine learning models trained on a corpus of image data and prompt tuning outcomes to predict the parameter values that will yield optimal results.

In block 304, the position selector, acting on the parameters received from block 302, can engage in a sophisticated selection process to identify the most suitable locations within a token sequence for the insertion of prompts. This can be a dynamic and multi-staged process, where the position selector evaluates various potential insertion points through computational models. These models might simulate the impact of different prompt positions on the model's performance, thereby guiding the selector to choose positions that align with an optimal balance of enhancing image feature recognition while maintaining processing efficiency. The selection strategy can be continuously updated, leveraging real-time feedback from the model's performance and adjusting the selection criteria to address the nuances of incoming image data and varying processing contexts.

Block 306 represents the token sequence data structure that organizes the series of tokens corresponding to discrete segments of the processed image. This data structure is integral to the system, forming the backbone of the prompt tuning operation by providing a well-defined framework for the integration of prompts. It can accommodate the dynamic insertion and repositioning of prompts, reflecting the system's adaptive nature. The data structure is formatted to ensure consistency and compatibility with the pre-trained vision model's architecture, enabling seamless processing and interpretation of the image data.

In various embodiments, the numerals 305, 307, and 309 within FIG. 3A denote potential locations within the token sequence where prompts could be inserted. These locations are considered by the position selector and represent the candidate positions that have been determined to potentially enhance the model's processing power. Each position is evaluated based on the parameters defined in block 302, with the system considering the contextual relevance and expected impact on the model's performance for each potential prompt location. Block 308, labeled as X₀, indicates the specific position selected by the position selector from among the candidates for the actual insertion of a prompt. The position chosen for X₀ can be the result of a calculated decision-making process designed to tailor the model's processing to the current image, taking into account factors such as the importance of different image features, the desired outcome of the processing task, and the historical performance of the model when processing similar images. The placement of a prompt at X₀ can significantly influence how the pre-trained vision model interprets the input data, potentially leading to more accurate outcomes in applications such as object detection, scene segmentation, and pattern recognition.

Collectively, the method depicted in FIG. 3A showcases the nuanced interplay between the dynamic prompt tuning system's components. It illustrates the intricate processes involved in enhancing a pre-trained vision model's capability to interpret and analyze images, enabling it to perform with greater accuracy and efficiency across various domains. This figure underscores the technical complexity and innovation of the present system, emphasizing its advancement beyond traditional static image processing techniques to a more flexible, adaptive, and intelligent image analysis solution, in accordance with aspects of the present invention.

Turning now to FIG. 3B, in various embodiments, a method for dynamically determining an optimal prompt length within a token sequence can be implemented for refining the capabilities of a vision model in image processing tasks, in accordance with aspects of the present invention. In block 312, a variety of parameters can be introduced into the system. These parameters can serve as inputs that influence the selection of prompt lengths, providing guidelines for how prompts can be dimensioned and inserted within a token sequence. The parameters can include data on the type of image being processed, the processing task's specific objectives, or performance metrics from previous prompt tuning exercises. The system can incorporate these parameters to determine the effective lengths of prompts that can be used to augment the model's ability to accurately process and interpret image data. Numeral 313 denotes prompt length as a variable within the system's operational matrix. Here, the appropriate size of the prompts can be determined, which could play a significant role in the subsequent performance of the model. This block can act as a control point where the system calibrates the length of the prompts to be used, taking into consideration the complexity of the visual information, the processing goals, and the need for computational efficiency in model execution.

Block 314 illustrates the prompt length selector, which can be responsible for applying the parameters from block 312 and the prompt length control from block 313 to generate a set of optimized prompts. This selector can use predictive modeling techniques to forecast which prompt lengths can yield improved performance in feature recognition and image classification tasks. The prompt length selector can be capable of adjusting the length of prompts in real-time, thereby enabling the system to respond to changes in image content, variations in task requirements, and shifts in performance objectives. Block 316 depicts the token sequence data structure, which organizes and manages the flow of tokenized image data ready for the integration of prompts. The token sequence can be a critical element of the model's architecture, as it holds the transformed image data in a format amenable to processing by the vision model. This structure is designed to be flexible, accommodating prompts of different lengths at various positions, facilitating the dynamic tuning of the model's input space.

Numerals 315, 317, and 319 within FIG. 3B signify a range of selectable lengths for prompts that the system can evaluate. These potential prompt lengths can be part of the decision-making process undertaken by the prompt length selector, ensuring that a wide array of options is considered for each image processing task. Numeral 318, marked as X₀, identifies a specific length that has been chosen for prompt insertion within the token sequence. This chosen length can be the result of a comprehensive analysis performed by the system, assessing the efficacy of various prompt lengths in relation to the desired processing outcomes. The selection of X₀ can represent a culmination of a multivariate optimization process, and can include evaluations of the impact of different prompt lengths on the accuracy and efficiency of the model's processing capabilities.

Collectively, the method shown in FIG. 3B illustrates various embodiments including sophisticated processes involved in the dynamic selection of prompt lengths for token sequences used in vision models for image processing. The diagram illustrates a nuanced approach to enhancing the model's interpretive accuracy and processing efficiency through the innovative application of dynamic prompt tuning, an advancement that differentiates this system from traditional image processing methods, in accordance with aspects of the present invention.

In various embodiments, the present invention can utilize learnable neural networks to automatically select insertion positions and prompt length using dynamic prompting (DP) to accommodate tuning with respect to task or instance aware position, length, and representation of soft prompts. In an illustrative example, first, one input image can be split into n fixed-sized patches Iⱼ. xᵢ=Embed(Iⱼ). Here, Embed(·) is one feature embedding function like Convnet. Then, one image can be transformed into a sequence x of n tokens, x={x₁, x₂, . . . , xₙ}, a pre-trained vision model LM_{θ} like ViT (vision transformer) can generate an embedding of the tokens X∈R^{n×e} where e is the dimension of the encoded representation. The prompt tuning can introduce a soft prompt P∈R^{p×e}, where p is the length of the soft prompts. The next step can include prepending the prompts P with actual inputs X into a matrix X′=[P; X], then X′ can be fed into the model LM_{θ} for optimization, where only parameters in P are optimized while the backbone vision pretrained model is frozen, in accordance with aspects of the present invention.

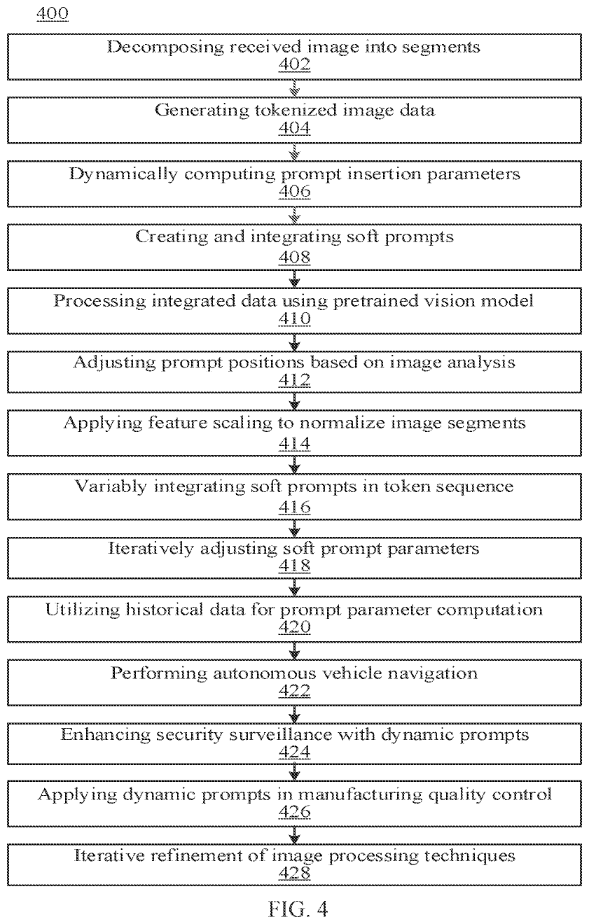

Referring now to FIG. 4, a diagram showing a method 400 for automated image processing and enhancement by integrated management and dynamic adjustment of soft prompts across various computer vision and image processing tasks, is illustratively depicted in accordance with embodiments of the present invention.

In various embodiments, in block 402, an image can be received and decomposed into segments that are optimally sized to facilitate subsequent processing steps. This decomposition is configured to ensure each segment retains sufficient detail for accurate feature recognition while being manageable for computational tasks. Algorithms can be employed to identify and segment based on structural and content-driven characteristics of the image, such as variations in color, texture, or luminance, which may dictate the boundaries of each segment. This process can be adjusted dynamically based on the specific requirements of the embedding algorithm intended for use in token generation.

In block 404, the decomposed image segments can be transformed into a sequence of tokens using an embedding process that incorporates a convolutional neural network (CNN). This transformation involves applying multiple layers of filters to extract various features from the image segments, converting these features into a structured token format that can be efficiently processed by neural network models. The parameters of the CNN, such as the number and size of filters, can be tailored based on the characteristics of the input image to optimize feature extraction. In block 406, parameters for the insertion of prompts into the token sequence can be dynamically computed. This computation can leverage a one-layer neural network equipped with a mechanism for the continuous relaxation of a discrete distribution, facilitating the optimization of decisions on the position and length of prompts. The chosen methodology allows for fine-tuning the insertion strategy in a way that can accommodate variations in image content and desired outcomes, enhancing the adaptability of the prompt tuning process.

In block 408, soft prompts can be created based on the parameters computed in the previous step and then integrated with the tokenized image data. The design of these prompts can be such that they subtly alter the processing pathway of the subsequent pretrained vision model, influencing its interpretive mechanisms to better align with the specifics of the input image. The integration process can ensure that these prompts are seamlessly blended within the existing token sequence, maintaining the natural flow of data through the model. In block 410, the image data, now enhanced with integrated soft prompts, can be processed using a pretrained vision model with a frozen backbone. This processing can exploit the pretrained capabilities of the model while using the newly added prompts to fine-tune the model's responses to specific features within the image. This step can enhance the model's ability to recognize and interpret complex features, potentially improving accuracy in tasks such as object detection or scene understanding.

In block 412, the positions of the soft prompts within the token sequence can be adjusted based on a detailed analysis of the received image. This analysis can involve examining the image's compositional elements to determine optimal prompt placement that maximizes the effectiveness of the model's feature recognition capabilities. Adjustments can be made dynamically and in real-time to respond to variations in image content, ensuring optimal model performance across different images. In block 414, a feature scaling technique can be applied to the image segments before tokenization. This normalization process can help standardize the input data into the embedding algorithm, promoting uniformity in the model's response to different segments of the image. Scaling can adjust the range of feature values so that outlier data does not skew the model's interpretative accuracy, facilitating more consistent outputs across varied inputs.

In block 416, soft prompts can be variably integrated within different layers of the token sequence to experiment with various configurations. This variability allows the system to explore multiple hypotheses regarding the optimal placement of prompts, which can be particularly useful in real-time image processing applications where conditions and requirements might rapidly change. In block 418, the parameters for soft prompts can be iteratively adjusted based on the output accuracy of the vision model. This iterative adjustment, facilitated by a feedback loop, can refine the performance of the model on specific image recognition tasks by continuously fine-tuning the prompt parameters to better suit the characteristics of the images being processed. In block 420, historical data from previous image processing tasks can be utilized to inform the dynamic computation of prompt parameters. This use of historical data can enhance the model's ability to generalize across different image datasets, allowing the system to adapt its prompt tuning strategies based on past successes and challenges.

In block 422, the processed image data can be used for real-time, accurate image recognition necessary for autonomous vehicle navigation. This application can include employing the dynamically tuned prompts to enhance the system's capabilities in detecting obstacles, making navigation decisions, and controlling the vehicle in a variety of environmental conditions. In block 424, the system can apply dynamic prompt tuning to enhance real-time recognition of variable objects, persons, and activities within a security surveillance system. This application can enable the system to adaptively recognize and respond to changes in the surveillance environment, improving the accuracy and reliability of the security measures. In block 426, dynamic prompt tuning can be utilized for precise image analysis aimed at detecting manufacturing defects in real-time. This application ensures that the system can adaptively tune the prompts based on the characteristics of the materials being inspected, leading to more effective and accurate defect detection in a manufacturing setting. In block 428, the entire system can be subject to continuous refinement and enhancement based on feedback from its applications in autonomous navigation, security surveillance, and manufacturing. This ongoing process can ensure that the image processing techniques remain effective, adaptable, and aligned with the latest technological advancements and operational parameters and requirements, in accordance with aspects of the present invention.

Referring now to FIG. 5, a diagram showing a system and method 500 for automated, multi-task dynamic prompt tuning across various computer vision and image processing tasks in multiple exemplary environments, is illustratively depicted in accordance with embodiments of the present invention.

In various embodiments, a computing network 501 can serve as a communication infrastructure connecting all the devices. This network can support a range of data transmission protocols and can handle high-bandwidth operations to facilitate real-time data exchange and coordination among the various system components. An end user 502, within this system, can engage with the technology using a user device 504. The user can initiate image processing tasks, provide input for customization of the image enhancement processes, and receive the processed outputs. The end user can interact with the system through a user interface that may allow for the specification of parameters, submission of images, or real-time feedback, which can be leveraged to fine-tune the processing algorithms. The user device 504 can be utilized to access and control the dynamic prompt tuning system. User devices can encompass a broad spectrum of technology, such as smartphones, tablets, laptops, and desktop computers. These devices can be equipped with specialized software that allows users to upload images for processing, adjust prompt tuning parameters, and visualize the enhanced images. The devices can also have varying processing capabilities, with some able to perform basic image processing tasks locally, while others may rely on remote servers for more complex computations.

A computing device 506 (e.g., server, user device, local, remote, etc.) can be utilized for executing the intricate computations involved in image processing and enhancement tasks. This device can be a server, user device, or a combination of local and remote processing units, equipped with powerful CPUs or GPUs capable of performing the intensive calculations required for dynamic prompt tuning. The computing device can operate the backend processes that include feature extraction, neural network training, and dynamic prompt parameter optimization. It can also host the algorithms that compute and adjust the prompt parameters, such as position and length, tailoring the image processing to the specific requirements of different tasks.

In block 508, dynamic prompt tuning can be applied to automate quality control processes in manufacturing environments. In some embodiments, the system can receive images of products on an assembly line and utilizes a dynamic prompt tuning mechanism to optimize the detection of defects. By dynamically computing and adjusting prompt parameters such as length and position, tailored to each product type or batch, the system can enhance feature recognition-identifying cracks, misalignments, or incorrect assemblies. The technology can adapt its tuning based on the specific materials and lighting conditions present, ensuring high accuracy in defect detection, which is crucial for maintaining product quality and safety standards. In block 510, the application of dynamic prompt tuning in medical imaging can include processing scans like MRIs or X-rays with enhanced precision. The system can dynamically adjust prompt parameters to highlight areas of potential medical concern, such as tumors or fractures. These adjustments are made by analyzing the initial image data, identifying regions requiring enhanced detail, and then applying prompts that modify the processing pathway of a pretrained vision model to focus on these areas. This method can significantly aid radiologists by providing clearer, more detailed images, thus improving diagnostic accuracy and speeding up treatment planning and execution of treatments.

In block 512, dynamic prompt tuning enhances the functionality of surveillance systems used in various security contexts. The system processes live video feeds, dynamically tuning prompts to improve the detection and recognition of specific objects, individuals, or activities. For instance, during an event with high foot traffic, the system can adjust prompts to enhance facial recognition or detect suspicious behaviors more effectively. The tuning is responsive to changes in camera angles, lighting, and environmental conditions, ensuring reliable surveillance across diverse scenarios. In block 514, dynamic prompt tuning can be utilized to process imagery from cameras mounted on autonomous vehicles. The system can dynamically adjust the prompts based on real-time environmental and contextual data—such as weather changes, varying traffic conditions, or different road types—to enhance the detection of road signs, pedestrians, and other vehicles. This tailored processing helps the vehicle's navigation system make more informed decisions, enhancing safety and efficiency in autonomous driving.

In block 510, the system can utilize dynamic prompt tuning to analyze user interactions with digital content and adjust the presentation based on detected preferences. By dynamically tuning the image processing prompts, the system can alter visual elements of the content to better align with user engagement patterns, such as emphasizing certain colors or resizing images to highlight preferred content. This application is particularly useful in digital marketing and online retail, where personalized content significantly impacts user experience and business outcomes.

In block 518, dynamic prompt tuning can be applied to environmental monitoring through the analysis of satellite and drone imagery. The system dynamically adjusts prompts to enhance the detection of environmental changes, such as deforestation rates or the spread of wildfires. By tailoring the image processing to specific environmental features and conditions, the technology can provide more accurate data to environmental scientists and response teams, aiding in quicker decision-making for intervention and conservation efforts. It is to be appreciated that although the above particular applications for dynamic prompt tuning have been described for illustrative purposes, the present invention can be applied in any sort of environment for computer vision tasks, including, for example, image processing and enhancement by automated dynamic prompt tuning, in accordance with aspects of the present invention.

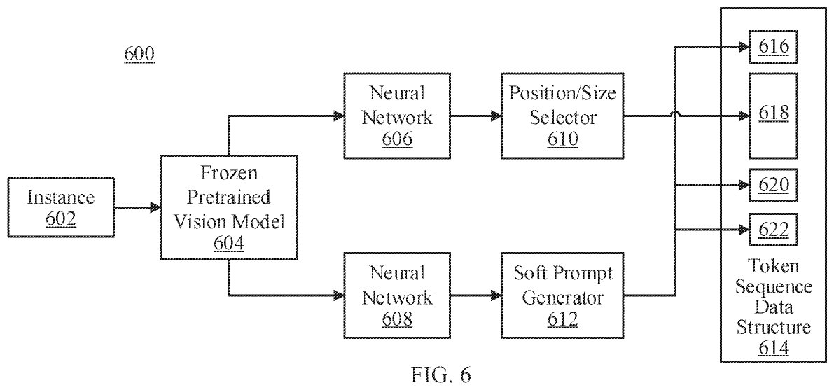

Referring now to FIG. 6, a diagram showing a system and method 600 for enhanced vision model analysis using dynamic prompt tuning, is illustratively depicted in accordance with embodiments of the present invention. In various embodiments, the system and method 600 can enhance vision model analysis by automated dynamic prompt tuning. This can include personalizing the dynamic prompt tuning to each instance, thereby streamlining the interpretative power of vision models used for a plethora of image processing applications.

In various embodiments, in block 602, an image instance can be input, marking the entry point of the system's workflow. This instance, which can range from high-resolution photographs to frames extracted from video streams, is the substrate upon which the system operates. The system can adapt to the nature of the instance, whether it requires processing for edge detection, feature extraction, or pattern recognition, ensuring that the subsequent steps are tailored to the specific needs of the image. The system can preprocess the instance to conform to the input parameters of the vision model, a step that can include adjustments in scale, format conversion, or normalization processes.

Block 604 encapsulates the frozen pretrained vision model that receives the preprocessed instance from block 602. Although the model's internal parameters are fixed, preserving the integrity of its original training, it can act as a robust foundation for feature extraction. The frozen state of the model can enable the system to capitalize on the stability and reliability of the extracted features without incurring the computational costs associated with retraining the model. The extracted features can serve as a detailed representation of the instance, providing the granularity needed for accurate prompt tuning.

Block 606 houses the first neural network of the system, which can leverage the extracted features from block 604 to analyze and inform the position/size selector in block 610. This neural network can synthesize the nuanced understanding of the instance's features to provide actionable insights for prompt positioning. It can process the intricate patterns and textures within the image, applying advanced analytical methods to recommend optimal positions for prompt insertion. This network can operate with an array of learning paradigms, potentially employing unsupervised, supervised, or reinforcement learning techniques to hone its predictive capabilities. Block 608 presents a second neural network that complements the analysis provided by block 606. This network can specialize in discerning the content and characteristics of the prompts that will be generated by block 612. It can analyze the context and significance of the instance, using its insights to craft prompts with semantic depth and relevance, thus enhancing the interpretative capabilities of the vision model.

Block 610, the position/size selector, can take the output from block 606 and dynamically determine the optimal positions and sizes for the prompts within the token sequence. This selector can combine the insights gained from the neural network with algorithmic strategies, such as optimization algorithms or heuristics, to navigate the complex decision space of prompt positioning. It can consider various factors, such as the image's semantic landscape, the distribution of salient features, and the objectives of the processing task, to make informed decisions about where and how prompts should be integrated into the token sequence.

In various embodiments, a concatenation of soft prompts and inputs can be simply a prefix of P into X. However, we can assume this kind of concatenation might not be the optimal strategy in this example. Intuitively, the prefixed P provides extra information for input sentences and offers an optimized alternative, but it may not be enough in some cases. Thus, the present invention can utilize dynamic position to fill the gap: dₚₒₛ is a parameter to be learned for different tasks or instances, then the original P can be split into two parts P=[P_{before}, P_{after}], where P_{before}=[P₁, P₂, . . . , P_{dpos-1}] and P_{after}=[P_{dpos}, . . . , Pₚ]. Then the new dynamic prompt becomes X′=[P_{before}; X; P_{after}], where dpos∈[0, p] is also a parameter to be learned and ancestral prompt tuning is a special case when dpos=p. Since dpos is a categorical data, we can use a one-layer network POSₚ and the Gumbel-Softmax to optimize it: logit=gumbel_softmax(POS_{g}(x), τ), where [symbol] is the anneal temperature adjusted by the total training steps.

In some embodiments, prompt length can also be dynamically learned by: P∈ [symbol] ^{n×e}, n=argmin loss([P; X]). Similarly, n∈[0, p] is also categorical data and can be optimized by a one-layer network LEN_{θ} and Gumbel-Softmax. Also, the additional parameters will be e*(p+1) and p+1 for task and instance-level, respectively. In practice, it can be challenging to implement such a mechanism since any model generally utilize a fixed dimension of the input matrix. Noting that the soft prompt length can significantly influence the final performance, the present invention can be utilized to automatically choose the optimal length without running many runs of different experiments, in accordance with aspects of the present invention.

Block 612, containing the soft prompt generator, can use the outputs from both neural networks to create prompts that are finely tuned for the instance. The generator can synthesize prompts that are well-suited to guide the vision model's analysis, ensuring that they enhance the model's focus on pertinent features and facilitate a more profound understanding of the image data. In some embodiments, dynamic prompts generation can be performed via the prompt pools. Specifically, as an illustrative example, assume there are a set of prompt pools Pool={P₁, . . . , Pₖ}, where k is the size of the pool. Then given any input x, we learn a small network Pool to get the attention score of every prompt Pᵢ with respect to x, the new soft prompts become:

$${P}_{new} = {\sum }_{i = 1}^{k} {α}_{i} * {P}_{i} , {α}_{i} = Softmax ( {Po}_{θ} ( {P}_{i} , x ) ) .$$

In practice, k controls the size of the prompt pool and additional parameters required. Since the P_{new} depends on a specific input instance, we denote this as an Adaptive vector on instance-level. This can be further enhanced in conjunction with the previous dynamic position method, where [P_{new}; X] can be optimized simultaneously to learn the most optimal position, in accordance with aspects of the present invention.

Block 614 illustrates the token sequence data structure, which organizes the tokenized image data along with the dynamically generated prompts. The structure can be vital for the coherent operation of the vision model, enabling the integration of the prompts into the token sequence while preserving the sequence's structured integrity. Blocks 616, 618, 620, and 622, each connected to the aforementioned components, represent output stages within the system's pipeline. Specifically, blocks 616, 620, and 622 can represent the system's processed outputs following the soft prompt generator in block 612. These blocks can indicate stages in the generation of prompts tailored for specific aspects of the model's interpretation tasks. Block 618, connected to the position/size selector in block 610, can indicate the processed decision regarding the prompt position and size, which is then applied to the token sequence data structure in block 614. This block can be essential for realizing the dynamic tuning process by specifying the final placement and dimension of the prompts within the token sequence.

The system and method 600 can include performing a sophisticated and adaptive method of enhancing the functionality of vision models. It highlights a process that tailors prompts to each instance, ensuring that the vision model can process images with enhanced accuracy and specificity. The system's flexibility and intelligence provide a nuanced solution to image analysis challenges, representing a significant advancement over static prompt tuning techniques, in accordance with aspects of the present invention.

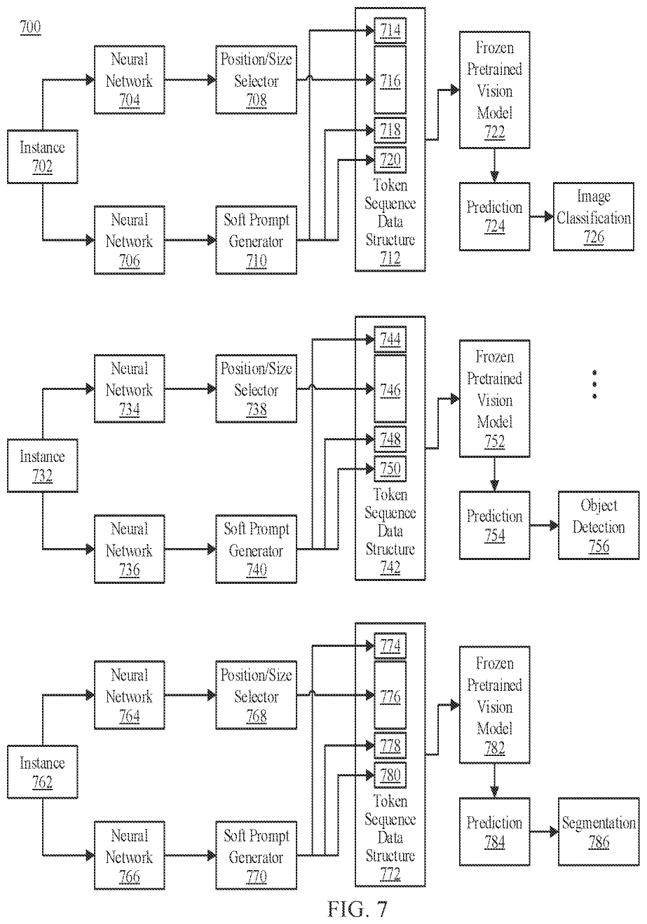

Referring now to FIG. 7, a diagram showing a system and method 700 for automated, multi-task dynamic prompt tuning for image processing and enhancement, is illustratively depicted in accordance with embodiments of the present invention. The system 700 can include a multi-task system architecture for dynamic vision prompting with a structure that supports concurrent image processing tasks, each benefitting from tailed dynamic prompt tuning. In various embodiments, at a high level, the system and method can include inputting training images and labels, together with pretrained vision model, utilizing the inputs to train the neural network for inferring the input position, length and generating soft-prompts, and for any new image, use the learned neural network to learn the soft-prompt and the insert position and length, and use the soft-prompt together and the text as the input to the language model to infer the output, then map the output to the label space for classification or other tasks, in accordance with aspects of the present invention.

In various embodiments, an image instance 702 can serve as the input for the multi-task system. It can be an image from varied domains such as medical imaging, surveillance footage, or photographs from a mobile device. This instance can be processed simultaneously by separate task-specific pipelines within the system, each capable of dynamically tuning prompts according to the unique requirements of the task at hand. A neural network 704 can analyze the instance 702, extracting pertinent features that inform the dynamic tuning process for each task. It can adapt its learning to the specifics of each task, whether it be recognizing anatomical structures in medical images or detecting objects in a traffic scene, ensuring that the prompt tuning is optimized for accuracy and relevance. Another neural network 706 can work in parallel with neural network 704, focusing on additional aspects of the image instance 702 necessary for a different set of tasks. This network can specialize in alternative feature sets or learning paradigms, contributing to the system's multi-tasking capability by providing complementary insights into the image data.

The position/size selector 708 can determine the optimal position and size for the soft prompts to be applied across different tasks. It can dynamically adjust these parameters for each task pipeline, ensuring that the prompts are situated in a manner that enhances the system's performance for a particular task, such as highlighting regions of interest in medical scans or critical elements in surveillance imagery. The soft prompt generator 710 can create prompts that are integrated into the token sequences of different task pipelines. It can generate a variety of prompts, each designed to direct the system's attention to task-relevant features within the image instance 702, thereby improving the system's capability to perform multiple tasks effectively and efficiently. A token sequence data structure 712 can organize the tokenized representation of the image instance 702 along with the dynamically generated prompts. This structure can ensure that the data is formatted correctly for each task-specific pipeline, allowing for simultaneous processing by multiple frozen pretrained vision models.

In various embodiments, blocks 714, 716, 718, and 720, each connected to the aforementioned components, represent output stages within the system's pipeline. Specifically, blocks 714,718, and 720 can represent the system's processed outputs following the soft prompt generator in block 710. These blocks can indicate stages in the generation of prompts tailored for specific aspects of the model's interpretation tasks. Block 716, connected to the position/size selector in block 708, can indicate the processed decision regarding the prompt position and size, which is then applied to the token sequence data structure in block 712. This block can be utilized for realizing the dynamic tuning process by specifying the final placement and dimension of the prompts within the token sequence.

Each task pipeline within the system can include its own frozen pretrained vision model 722. These models can interpret the token sequences enhanced by the dynamically generated prompts, making predictions or analyses specific to their respective tasks, such as classifying images, detecting objects, or segmenting image regions. Predictions 724 generated by each vision model 722 can be task-specific. The system can leverage the dynamically tuned prompts to produce precise predictions for a range of tasks, demonstrating the system's flexibility and multi-tasking strengths. In one task pipeline, for example, a task pipeline for image classification 726 can be performed where the system classifies the image instance 702 into predefined categories based on the features emphasized by the dynamic prompts, in accordance with aspects of the present invention.

In various embodiments, an additional image instance 732 can be input into the system, and can represent a different category or domain from instance 702. This can involve another modality of imaging or a new set of conditions, scenarios, or objects to be recognized or classified by the system. Additional neural networks 734 and 736 can process instance 732 to extract relevant features. These neural networks, while similar in function to 704 and 706, can be part of a separate task pipeline and can utilize shared parameters, enabling the neural networks to benefit from cross-task knowledge transfer, which can improve performance on each individual task through learned generalizations.

The position/size selector 738 can dynamically determine the optimal parameters for prompt placement specific to the task associated with instance 732. The selected prompt attributes can be informed by the shared parameters learned across tasks, facilitating a cohesive multi-task learning environment. A soft prompt generator 740 creates prompts tailored to instance 732. These prompts can be integrated into the token sequence and can be informed by shared parameters, ensuring consistency and efficiency in the prompt generation process across multiple tasks. The token sequence data structure 742 can organize the tokenized features from instance 732 along with the generated prompts, preparing the sequence for processing in a similar manner as structure 712, leveraging the shared parameters for prompt integration.

Blocks 744, 746, 748, and 740, each connected to the aforementioned components, represent output stages within the system's pipeline. Specifically, blocks 744, 748, and 740 can represent the system's processed outputs following the soft prompt generator in block 740. These blocks can indicate stages in the generation of prompts tailored for specific aspects of the model's interpretation tasks. Block 746, connected to the position/size selector in block 738, can indicate the processed decision regarding the prompt position and size, which is then applied to the token sequence data structure in block 742. This block can be utilized for realizing the dynamic tuning process by specifying the final placement and dimension of the prompts within the token sequence.

The system can utilize a pretrained frozen vision model in block 752, similarly to the models associated with instance 702, to process the token sequence and generate task-specific predictions for instance 732. The predictions 754 made by the pretrained frozen vision model 752 can be informed by the shared parameters and dynamic prompts, offering specialized analyses or classifications for instance 732 that are coherent with the multi-task learning strategy. In block 756, object detection can be conducted for instance 732, with the system detecting objects of interest specified by a user. The object detection can benefit from the shared learning parameters, leading to more accurate and efficient object detection across various tasks and environments, in accordance with aspects of the present invention.

In various embodiments, an additional image instance 762 can be input to the system, which can represent a different category or domain from instance 702 and 732. This can include, for example, another modality of imaging or a new set of conditions, scenarios, objects to be recognized or classified by the system, etc., in accordance with aspects of the present invention. Neural networks 764 and 766 can process instance 762 to extract relevant features. These neural networks, while similar in function to 704, 706, 734, and 736, can be a part of a separate task pipeline and can utilize shared parameters, enabling the network to benefit from cross-task knowledge transfer, which can be utilized for improving performance on each individual task through learned generalizations.

The position/size selector 768 can dynamically determine optimal parameters for prompt placement specific to the task associated with instance 762. The selected prompt attributes can be informed by the shared parameters learned across tasks, facilitating a cohesive multi-task learning environment. A soft prompt generator 770 can create prompts tailored to instance 762. These prompts can be integrated into the token sequence and can be informed by shared parameters, ensuring consistency and efficiency in the prompt generation process across multiple tasks.

The token sequence data structure 772 can be utilized to organize the tokenized features from instance 762 along with the generated prompts, preparing the sequence for processing in a similar manner as structures 712 and 742, leveraging the shared parameters for prompt integration. Blocks 774, 776, 778, and 780, each connected to the aforementioned components, can represent output stages within the system's pipeline. Specifically, blocks 774, 778, and 780 can represent the system's processed outputs following the soft prompt generator in block 770. These blocks can indicate stages in the generation of prompts tailored for specific aspects of the model's interpretation tasks. Block 776, connected to the position/size selector in block 768, can indicate the processed decision regarding the prompt position and size, which is then applied to the token sequence data structure in block 772. This block can be utilized for realizing the dynamic tuning process by specifying the final placement and dimension of the prompts within the token sequence.

In various embodiments, the system can utilize a pretrained frozen vision model 782, similarly to the models associated with instances 702 and 732, to process the token sequence and generate task-specific predictions for instance 762. The predictions 784 made by the pretrained frozen vision model 782 can be informed by the shared parameters and dynamic prompts, offering specialized analyses or classifications for instance 762 that are coherent with the multi-task learning strategy. In block 786, segmentation can be concurrently conducted with the image classification 726 and the object detection 756 to prepare data for further processing. The segmentation can benefit from the shared learning parameters, leading to more accurate and efficient segmentation across various tasks and environments, in accordance with aspects of the present invention.

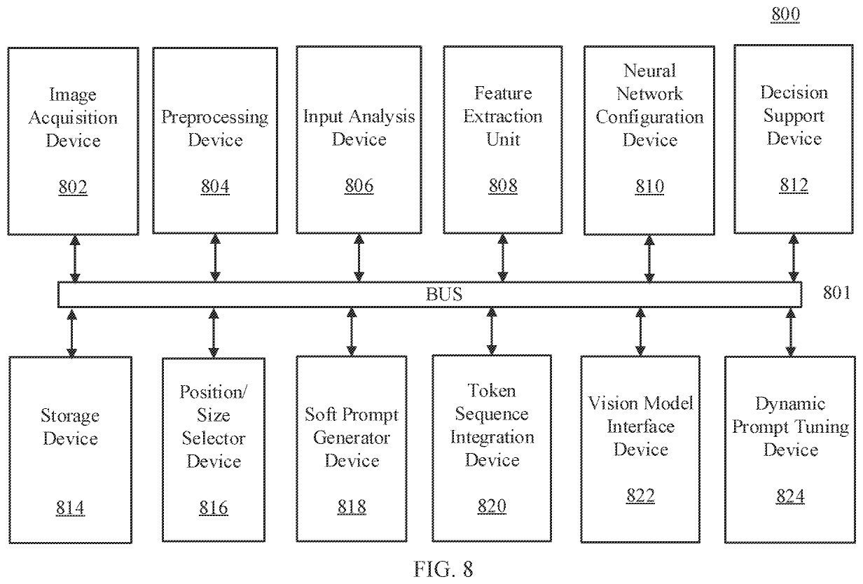

Referring now to FIG. 8, a diagram showing a system 800 for automated image processing and enhancement using dynamic prompt tuning, is illustratively depicted in accordance with embodiments of the present invention.

In various embodiments, an image acquisition device 802 (e.g., camera, smartphone, image downloader, etc.) can be utilized for sourcing visual data, and can be equipped to interface with a plethora of image-producing technologies. This device can have the capability to adapt incoming imagery from analog or digital formats into a uniform standard suitable for advanced processing. It can accommodate a spectrum of resolutions, dynamic ranges, and color spaces, ensuring comprehensive compatibility with various imaging requirements. A preprocessing device 804 can engage in the meticulous refinement of image data. This device can be adept at executing a multitude of image enhancement techniques, including but not limited to geometric transformations, noise reduction, and the application of image filters. The device can be particularly effective in standardizing image characteristics, such as orientation and scale, to conform with the input requisites of the most discerning feature extraction methodologies.

An input analysis device 806 can scrutinize the prepared images to uncover foundational features that are vital for the dynamic prompt tuning mechanism. It can utilize state-of-the-art image processing algorithms to identify and categorize various visual attributes, which can serve as preliminary indicators for the selection and customization of prompts in subsequent processes. A feature extraction device 808 can be tasked with distilling complex visual information into a streamlined feature set. Harnessing the capabilities of a frozen pretrained vision model, this device can extract a condensed yet informative representation of the visual data, encoding it into a format that is amenable to manipulation and analysis by deep learning frameworks. A neural network configuration device 810 can host an ensemble of neural networks, each calibrated to process the encoded features from the preceding device. These networks can have the role of deciphering the intricate patterns within the data, with the aim of determining the most efficacious prompt characteristics, encompassing positioning, sizing, and semantic content, that can later be synthesized and applied to the vision model, in accordance with aspects of the present invention.

A decision support device 812 can act as the nexus for neural network deliberations, integrating their output to formulate a cohesive strategy for prompt application. This device can leverage advanced decision-making algorithms to refine the collective intelligence of the neural networks into a strategic approach for prompt integration. A storage device 814 can serve as a repository for the multitude of data elements generated and utilized by the system. This device can ensure that all forms of data, from raw imagery to the nuanced parameters of dynamic prompts, are persistently and securely stored, ready for retrieval and manipulation by the system's various components in real-time.

A position/size selector device 816 can dynamically ascertain the most advantageous positions and dimensions for prompt placement within the tokenized image sequences. Utilizing complex computational models, this device can extrapolate from the data to select particular prompt characteristics that are tailored to maximize interpretative performance across any of a plurality of diverse visual tasks. The soft prompt generator device 818 can craft the prompts in accordance with the specifications outlined by the position/size selector device 816. It can fabricate prompts that not only conform to the determined parameters but are also imbued with semantic richness, enhancing their ability to guide and improve the vision model's analysis of image data. A token sequence integration device 820 can amalgamate the tokenized feature data with the soft prompts, creating a harmonious token sequence. This device can ensure that the integration process adheres to the structural integrity of the token sequence while infusing it with the dynamically tuned prompts for utilization for advanced image interpretation.

A vision model interface device 822 can be utilized for interfacing the integrated token sequence with the vision model. It can handle the intricacies of data format compatibility and synchronization, ensuring that the vision model can seamlessly process the enhanced token sequence. A dynamic prompt tuning device 824 can orchestrate the application of the dynamically generated prompts within the vision model. This device can oversee the fine-tuning of prompts in real-time, ensuring that each image is processed with the most effective prompt configuration. It can evaluate the model's performance, utilizing feedback mechanisms to continuously refine the prompt attributes, thus achieving a state of perpetual optimization. A central BUS 801 can provide a robust communication infrastructure, enabling the seamless exchange of data and commands between the interconnected devices. This bus can be utilized for maintaining the high throughput and low latency desired for real-time or near-real-time image processing scenarios. Each of the above components can play a strategic role in the system 800, collectively forming an infrastructure that can significantly enhance the capability of vision models through the interplay between components to adaptively improve image processing, in accordance with aspects of the present invention.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment,” as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A computer-implemented method for dynamic prompt tuning in image processing, comprising:
decomposing a received image into segments sized to balance detail retention and computational efficiency for processing by an embedding algorithm designed for token generation;
generating tokenized image data by transforming each of the decomposed segments into a sequence of tokens using an embedding process that includes a convolutional neural network;
dynamically computing parameters for inserting prompts into the sequence of tokens, including a position and length of the prompts, utilizing a one-layer neural network combined with a continuous relaxation of a discrete distribution for optimizing categorical decision-making;
creating soft prompts based on the dynamically computed parameters and integrating the soft prompts with the tokenized image data; and
processing the integrated image data and prompts using a pretrained vision model with a frozen backbone to enhance image feature recognition.

2. The method of claim 1, wherein the dynamic computation of the prompt parameters further includes adjusting a position of the soft prompts within the token sequence based on an analysis of the received image to optimize activation patterns within the pretrained vision model.

3. The method of claim 1, wherein the embedding process further comprises applying a feature scaling technique to normalize the image segments before tokenization to improve a consistency of input data fed into the pretrained vision model.

4. The method of claim 1, wherein the soft prompts are variably integrated within different layers of the token sequence to test various hypotheses for optimal prompt placement regarding the image processing in real-time during use.

5. The method of claim 1, further comprising iteratively adjusting the soft prompt parameters based on a determined output accuracy of the vision model using a feedback loop to refine performance of the model on specific image recognition tasks.

6. The method of claim 5, wherein the feedback loop utilizes historical data from previous image processing tasks to inform the dynamic computation of prompt parameters to enhance an ability of the model to generalize across different image datasets.

7. The method of claim 1, further comprising performing autonomous vehicle navigation utilizing the processed image data for real-time accurate image recognition for obstacle detection, decision making, and autonomous vehicle navigation control.

8. A system for dynamic prompt tuning in image processing, comprising:
a processor device; and
a memory storing instructions that, when executed by the processor device, cause the system to:
decompose a received image into segments sized to balance detail retention and computational efficiency for processing by an embedding algorithm designed for token generation;
generate tokenized image data by transforming each of the decomposed segments into a sequence of tokens using an embedding process that includes a convolutional neural network;
dynamically compute parameters for inserting prompts into the sequence of tokens, including a position and length of the prompts, utilizing a one-layer neural network combined with a continuous relaxation of a discrete distribution for optimizing categorical decision-making;
create soft prompts based on the dynamically computed parameters and integrate the soft prompts with the tokenized image data; and
process the integrated image data and prompts using a pretrained vision model with a frozen backbone to enhance image feature recognition.

9. The system of claim 8, wherein the instructions further cause the system to adjust a position of the soft prompts within the token sequence based on an analysis of the received image to optimize activation patterns within the pretrained vision model.

10. The system of claim 8, wherein the embedding process includes an application of a feature scaling technique to normalize image segments before tokenization to improve a consistency of input data fed into the pretrained vision model.

11. The system of claim 8, wherein the instructions further cause the system to variably integrate the soft prompts within different layers of the token sequence to test various hypotheses for optimal prompt placement regarding the image processing in real-time during use.

12. The system of claim 8, wherein the system includes a feedback loop controlled by the instructions to iteratively adjust soft prompt parameters based on output accuracy of the vision model to refine performance of the model on specific image recognition tasks.

13. The system of claim 12, wherein the feedback loop utilizes historical data from previous image processing tasks to inform the dynamic computation of prompt parameters to enhance an ability of the model to generalize across different image datasets.

14. The system of claim 13, wherein the instructions further cause the system to perform dynamic prompt tuning of the prompt parameters and utilizing the tuned prompts for real-time variable object, person, and activity recognition in a security surveillance system to enhance recognition of the variable object, person, and activity in different environmental conditions.

15. A computer program product for dynamic prompt tuning in image processing, the computer program product comprising a computer readable storage medium having program instructions embodied therewith, the program instructions executable by a hardware processor to cause the hardware processor to:
decompose a received image into segments sized to balance detail retention and computational efficiency for processing by an embedding algorithm designed for token generation;
generate tokenized image data by transforming each of the decomposed segments into a sequence of tokens using an embedding process that includes a convolutional neural network;
dynamically compute parameters for inserting prompts into the sequence of tokens, including a position and length of the prompts, utilizing a one-layer neural network combined with a continuous relaxation of a discrete distribution for optimizing categorical decision-making;
create soft prompts based on the dynamically computed parameters and integrate the soft prompts with the tokenized image data; and
process the integrated image data and prompts using a pretrained vision model with a frozen backbone to enhance image feature recognition.

16. The computer program product of claim 15, wherein the program instructions further cause the hardware processor to adjust a position of the soft prompts within the token sequence based on an analysis of the received image to optimize activation patterns within the pretrained vision model.

17. The computer program product of claim 15, wherein the embedding process includes an application of a feature scaling technique to normalize image segments before tokenization to improve a consistency of input data fed into the pretrained vision model.

18. The computer program product of claim 15, wherein the program instructions further cause the hardware processor to variably integrate the soft prompts within different layers of the token sequence to test various hypotheses for optimal prompt placement regarding the image processing in real-time during use.

19. The computer program product of claim 15, wherein the program instructions further cause the hardware processor to manage a feedback loop to iteratively adjust soft prompt parameters based on output accuracy of the vision model to refine performance of the model on specific image recognition tasks, the feedback loop utilizing historical data from previous image processing tasks to inform a dynamic computation of prompt parameters to enhance an ability of the model to generalize across different image datasets.

20. The computer program product of claim 19, wherein the program instructions further cause the hardware processor to perform precise image analysis by dynamic prompt tuning of prompt parameters, and to utilize the tuned prompts for automated, real-time detection of manufacturing defects for quality control in a manufacturing facility.
